(19) United States
(12) Patent Application Publication
(10) Pub. No.: US 2016/0358286 A1
(43) Pub. Date: Dec. 8, 2016

(54) COMPUTERIZED DUAL ELIGIBILITY TRACKING SYSTEM AND METHOD

(71) Applicant: Michael Sallee, Louisville, KY (US)

(72) Inventor: Michael Sallee, Louisville, KY (US)

(73) Assignee: HUMANA INC., Louisville, KY (US)

(21) Appl. No.: 13/549,979

(22) Filed: Jul. 16, 2012

(51) Int. Cl. G06Q 40/08; G06Q 50/24

(52) U.S. Cl. CPC G06Q 50/22

(57) ABSTRACT

A computerized system and method for tracking applications and other information for “dual eligible” members of a health insurance plan. The users of computerized system and method are associates of a health benefits provider that offers Medicare Advantage insurance plans to individuals who also may qualify for additional health benefits under another program such as Medicaid. The associates may use the computerized system and method to track activities and interactions with members to qualify them for and to assist them in enrolling in state Medicaid programs. The computerized system and method support tracking of interactions using voice activated technology (VAT) as well as direct mail efforts. The computerized system and method further support recording a member's contact preferences to facilitate additional communications with the member that may be required to complete the eligibility evaluation and for members that are eligible, the enrollment process.

### CROSS-REFERENCE TO RELATED APPLICATIONS

None.

### BACKGROUND OF THE INVENTION

The Medicare program is a governmental health insurance program that provides healthcare benefits to millions of individuals. The program is comprised of four parts:

TABLE 1
Medicare Insurance and Benefits

| | |
|---|---|
| Part A | Hospital Insurance |
| Part B | Medical Insurance |
| Part C | Medicare Advantage Plus |
| Part D | Prescription |

The federal government has established guidelines to determine eligibility for program benefits. Individuals at least 65 years of age are generally eligible for the Medicare program. Although Medicare Parts A and B cover most of the medical expenses that individuals are likely to incur, they do not cover all medical expenses. For example, under certain circumstances, covered individuals are responsible for out-of-pocket costs such as prescription drugs or services that are not fully covered. For low income individuals, these costs may be covered under a Medicaid Savings Program (MSP), the federal government's state-based health program for low income individuals and families. Individuals that qualify for Medicare Parts A and B, as well as certain MSP benefits, are considered “dual eligible.” The procedure for determining benefits for a “dual eligible” individual involves numerous health and income considerations.

Individuals who are eligible for Medicare may choose to purchase a “Medicare Advantage” (Part C) insurance plan that covers medical costs under Parts A and B. Such plans may also include prescription drug coverage (Part D). Medicare Advantage plans must comply with government requirements and regulations but are provided by private insurance companies. In many instances, the providers offer extra coverage for vision, hearing, and dental claims and for wellness programs. Although providers that offer Medicare Advantage plans must follow rules established by Medicare, each provider has its own enrollment and benefits administration procedures as well as levels of coverage for “extras.” Therefore, qualifying individuals are free to “shop” for the plan that best meets their needs.

Under current rules, US citizens are eligible for Medicare as soon as they reach age 65. There are no income or other requirements that must be met. Individuals that become eligible for Medicare and are concerned about associated out-of-pocket costs or services that may not be covered may choose to contact a private insurance company to purchase a Medicare Advantage insurance plan. What they may not realize when they decide to contact a private insurer is that they may actually qualify for MSP benefits that will cover various medical costs not covered by Medicare under a Medicare Advantage insurance plan. In other words, they may not realize they are considered “dual eligible.” Even if they know they are “dual eligible,” they may not understand the procedures for enrolling in and obtaining benefits under both programs. Furthermore, circumstances for members of a Medicare Advantage plan may change such that an individual that was previously ineligible for MSP benefits may later become eligible. Therefore, it is beneficial to individuals to periodically reevaluate their eligibility.

Private insurers that offer Medicare Advantage plans are in a unique position to help their members that may also qualify for state MSP benefits. Insurance company associates may assist individuals with understanding MSP benefits requirements as well as directing them to the appropriate resources and assisting them with completion of eligibility and enrollment procedures. Because Medicaid is a needs-based program and the requirements may vary from state to state, enrolling members for MSP benefits can be complex and may require the submission of a substantial amount of information and documentation to one or more agencies. Tracking eligibility applications may require tracking a substantial amount of information and documentation as well as interactions with the potential beneficiary and agencies. For insurance company associates that may be assisting numerous Medicare Advantage plan members, tracking such details for a large number of individuals can quickly become overwhelming. There is a need for a computerized system and method for tracking applications and other information for “dual eligible” members of a health insurance plan.

### SUMMARY OF THE INVENTION

The present disclosure relates to a computerized system and method for tracking applications and other information for “dual eligible” members of a health insurance plan. The users of the computerized system and method are associates of a health benefits provider that offers Medicare Advantage insurance plans to individuals who also may qualify for additional health benefits under another program such as Medicaid. The associates may use the computerized system and method to track activities and interactions with members to qualify them for and to assist them in enrolling in state Medicaid programs. The computerized system and method support tracking of interactions using voice activated technology (VAT) as well as direct mail efforts. The computerized system and method further support recording a member's contact preferences to facilitate additional communications with the member that may be required to complete the eligibility evaluation and for members that are eligible, the enrollment process.

The computerized system and method provides a user with a comprehensive view of member interactions as well as the status of a member's eligibility evaluation and application or enrollment process. Access to information regarding the requirements and enrollment process for numerous programs is provided so a user can quickly determine the additional steps that a member may need to take to complete the eligibility evaluation and application or enrollment process. The tracking details and member preference data allow a user to determine efficiently and effectively the additional information from the member that is required and the most appropriate method of communicating with the member to obtain the needed information. The computerized system and method further supports ending the eligibility or enrollment process under certain circumstances.

### BRIEF DESCRIPTION OF THE DRAWINGS

FIG. 1 is a sample “member selection” screen according to an example embodiment;

FIG. 2 is a sample “member validation and activity” screen according to an example embodiment;

FIGS. 3A-3O illustrate activity tab functionality for an example embodiment;

FIGS. 4A-4E are sample screens for call tracking features according to an example embodiment;

FIG. 5 is a sample contact history screen according to an example embodiment;

FIGS. 6A-6C, are sample alternate information screens according to an example embodiment;

FIGS. 7A-7H are sample screens for tracking spousal information according to an example embodiment;

FIGS. 8A-8B are sample caseworker screens according to an example embodiment;

FIG. 9 is a sample “today's members” screen according to an example embodiment;

FIGS. 10A-10O are sample “add new member” screens according to an example embodiment; and

FIGS. 11A and 11B are sample “activity search” screens according to an example embodiment.

### DETAILED DESCRIPTION

The computerized system and method of the present disclosure is a “dual eligible” software tracking application that stores member contact information as well as detailed status information for member applications to enroll in a supplemental health benefits program. The software tracking application provides features and functionality for comprehensive member case management. It supports the entry and recording of activity data related to efforts to qualify a “dual eligible” member for MSP benefits and to complete the enrollment process. A member's “dual eligibility” may initially be identified in connection with a member “dual eligibility outreach” (DEO) effort in which associates of a health benefits provider contact Medicare Advantage clients and screen them for possible dual eligibility.

The screens of the software tracking application provide dual eligibility outreach associates with access to the current status of a member's case. The application tracks “call batch files” into which member data is loaded so that an associate can make thorough and accurate updates to the information after every call made during an outreach effort. The screens also allow an associate to access information about program requirements so that the associate can provide members with accurate information and assist them in enrollment. If eligibility or enrollment efforts must be discontinued for any reason, the screens also allow the associate to record details and reasons for the change.

In an example embodiment, the software application provides access to:
Member demographic data
Member provider data
Member health plan data
Member CMS data
Member predictive modeling scores
Member no contact requests
Referral source data
DEO member mailings
DEO-VAT call attempts and outcomes
DEO-DMS call attempts and outcomes
A history of contact and activity completed by the DEO staff
DEO user and access rights data
Customized activity reports

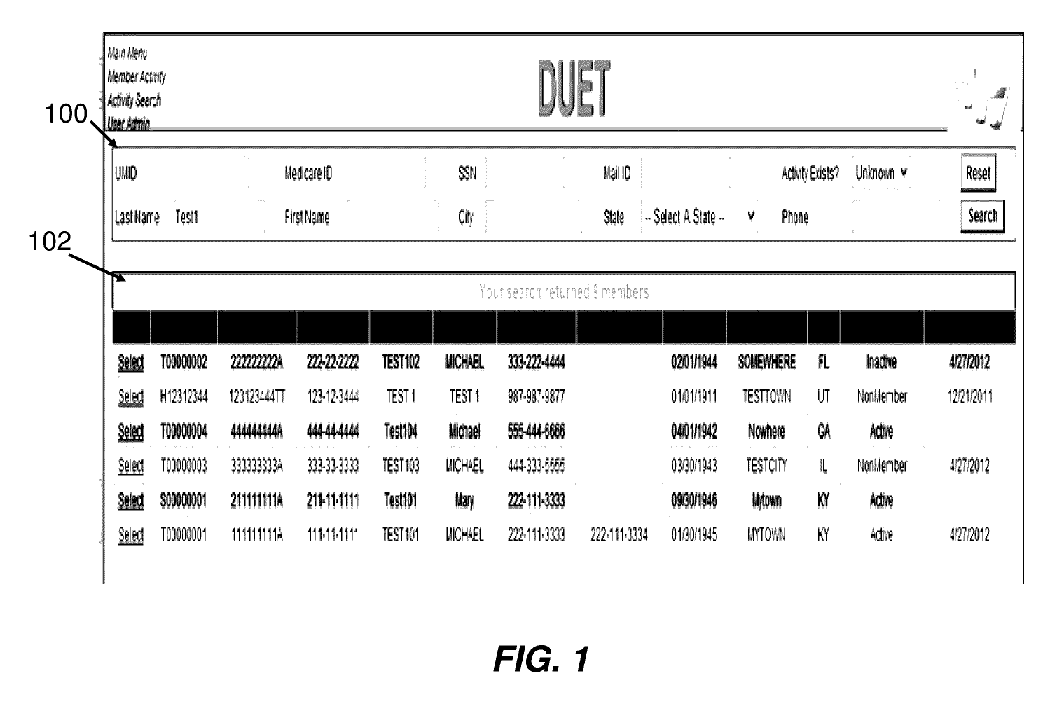

Referring to FIG. 1, a sample “member selection” screen according to an example embodiment is shown. A computer user may enter search criteria in a top portion of the screen 100. Search results are displayed in a bottom portion of the screen 102. Member data includes a unique member identifier (UMID), Medicare identifier, social security number (SSN), the member's name, telephone number, date of birth, address, member status, and last status date. 100 as well as.

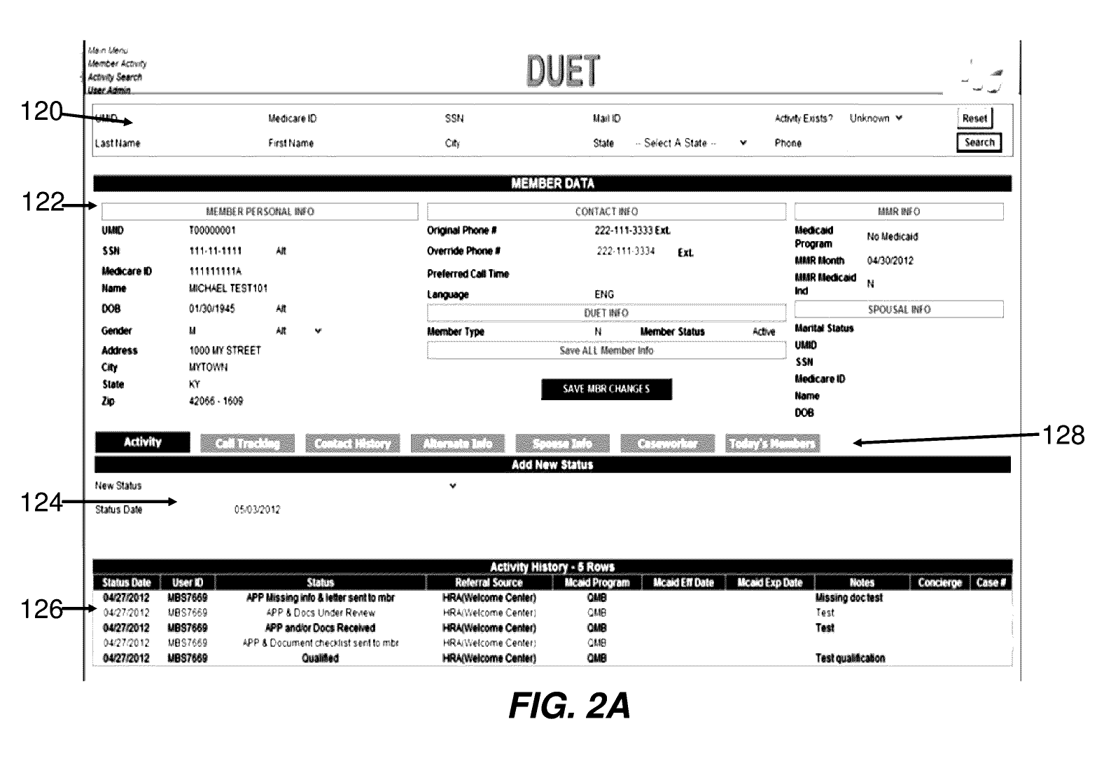

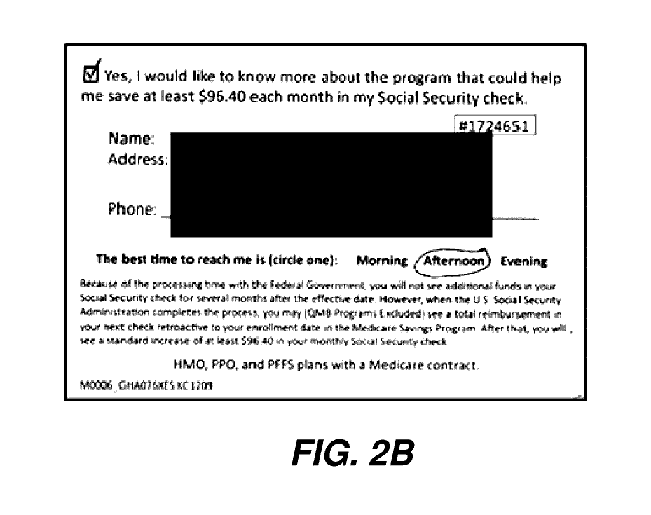

Referring to FIG. 2, a sample “member validation and activity” screen according to an example embodiment is shown. The screen comprises a member search box 120 for entering search criteria and performing a search. The screen further comprises a “member data” section 122 for displaying a member's personal information, contact information, dual eligibility status, Medicaid program data, and spousal information. The member data section 122 contains a number of data elements that are useful in the MSP screening and qualification process. In an example embodiment, the member data section may have a different color background as a visual cue for different groups of members. The standard background may be a gray color that represents all active members except those that reside in a particular state. A different color background may be used for a state that has, for example, an income rule applicable only to married couples. The background color serves as a reminder that there is a rule that only applies to married couples in the particular state. Another color may be used to indicate inactive members and yet another color may be used to indicate non-members. Different color background may serve as visual indicators for a variety of rules.

Details of the member data section are as follows.

TABLE 2
Member Data

| | |
|---|---|
| MEMBER | “MEMBER PERSONAL INFO” area contains the member's |
| PERSONAL | UMID, SSN, Medicare identifier, name, date of birth, gender, |
| INFO | address, city, state, and zip code. If necessary, a corrected SSN, |
| | DOB, and/or gender may be entered in the empty boxes labeled |
| | “Alt.” The “SAVE MBR CHANGES” option saves any data |
| | entered in these boxes. The original data remains in the same |
| | positions after entering corrected data and the corrected data |
| | appears in the boxes labeled “Alt”. |
| CONTACT | “CONTACT INFO” area contains Original Phone Number, |
| INFO | Override Phone Number, Preferred Call Time, and Language |
| | preference. An alternate phone number can be entered in the |
| | “Override Phone#” box and if needed an extension can be |
| | entered in the “Ext” box. The “Preferred Call Time” box is |
| | available under certain conditions. If the member has received a |
| | mailing, returned an attached postcard, and the search included |
| | the “Mail ID” number contained on the postcard, the user may |
| | enter the preferred call time noted on the postcard. This |
| | information is used when creating a VAT call file for members |
| | asking for a callback from the mailing campaigns. When |
| | searching on any criteria other than “Mail ID,” this box displays |
| | data but is grayed out and unavailable for data entry. The “SAVE |
| | MBR CHANGES” option saves any information entered in this |
| | area. |
| DUET | “DUET INFO” area contains the Member Type and the Member |
| INFO | Status. The Member Type is based on the member's current and |
| | past MSP status. The type listed on DUET will be either “N”, “R”, |
| | or “U.” |
| | N - This means this member is not currently on MSP and has |
| | not been on MSP within the past year. |
| | R - This means that the member is a Recert, which means they |
| | were on Medicaid or MSP at some time in the past two years |
| | and may still be on the program. |
| | U - This means the member is either a new member or a non- |
| | member and the Medicaid or MSP status is unknown. |
| | The Member Status is “Active”, “Inactive”, or “NonMember.” The |
| | Member Status indicates whether the individual is currently |
| | enrolled in a benefits plan (Active) or was enrolled in a benefits |
| | plan in the past (Inactive), or the person is not a member |
| | (NonMember). The “NonMember” status may also be shown for |
| | new members that have not yet been added to software |
| | application. |
| Save ALL | This section contains the “SAVE MBR CHANGES” button. |
| Member | |
| Info | |
| MMR INFO | This area displays information from the CMS Monthly |
| | Membership Detail Data file relevant to dual eligible status. The |
| | “Medicaid Program” listed in the MMR, if any, is displayed. The |
| | “MMR Month” indicates the ending date of the MMR's coverage |
| | month from which the information came. The “MMR Medicaid |
| | Ind” displays a “Y”, “N,” or is blank. If the indicator is “Y,” CMS |
| | data currently lists the member as on some type of MSP. If the |
| | indicator is “N,” CMS data indicates the member is not on any |
| | type of MSP. If this area is blank, the MMR did not contain a |
| | Medicaid Indicator value. There is a time lag from the time a |
| | state issues a program determination and notifies CMS and from |
| | this notification to the updated information being included in the |
| | MMR. This time lag can span multiple months so the MMR |
| | Medicaid indicator does not necessarily reflect a member's |
| | current MSP status. |
| SPOUSAL | This area contains information about the member's spouse, if |
| INFO | any has been entered by the DEO group. The section contains |
| | the member's Marital Status, the spouse's UMID, SSN, |
| | Medicare ID, Name, and DOB. |

Referring to FIG. 2B, a sample postcard according to an example embodiment is shown.

Referring again to FIG. 2A, the screen also comprises an activity history section 126 with information related to one or more activities for confirming a member's dual eligibility. The screen allows a user to enter new status information and a new status date related to additional activities for confirming dual eligibility 124. Finally, the screen comprises a number of tabs 128 for accessing different functions associated with the member data. In an example embodiment, the following functions are accessible: Activity; Call Tracking; Contact History; Alternate Info; Spouse Info; Caseworker; and Today's Members.

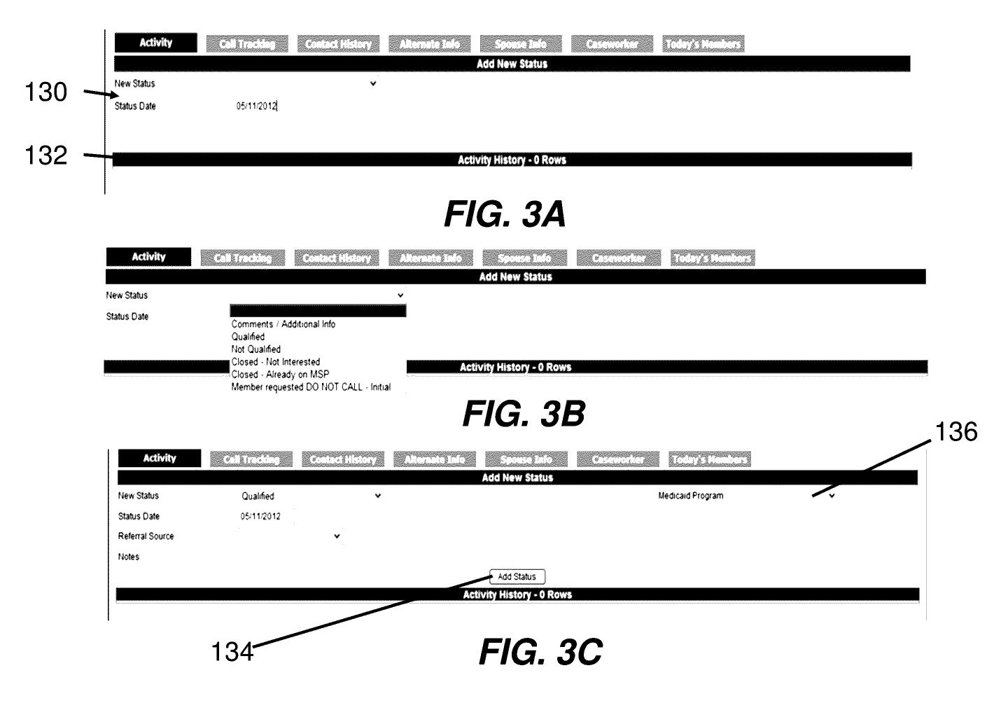

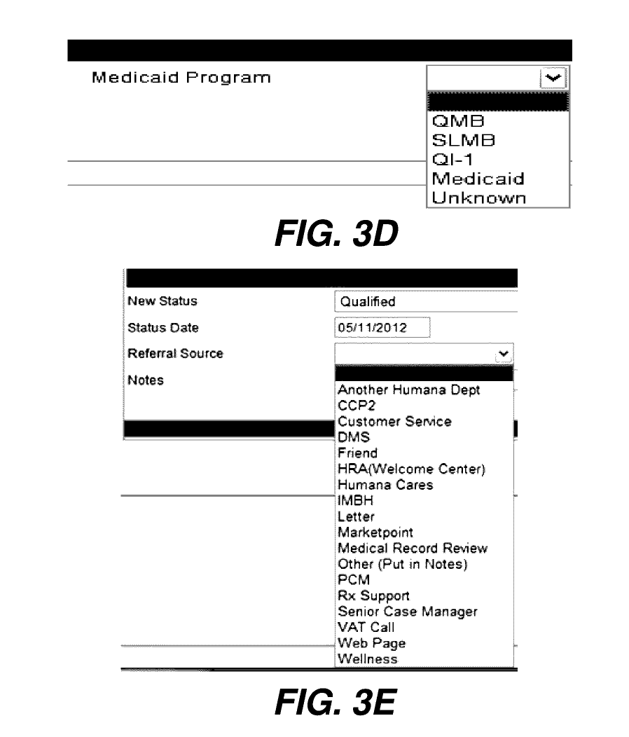

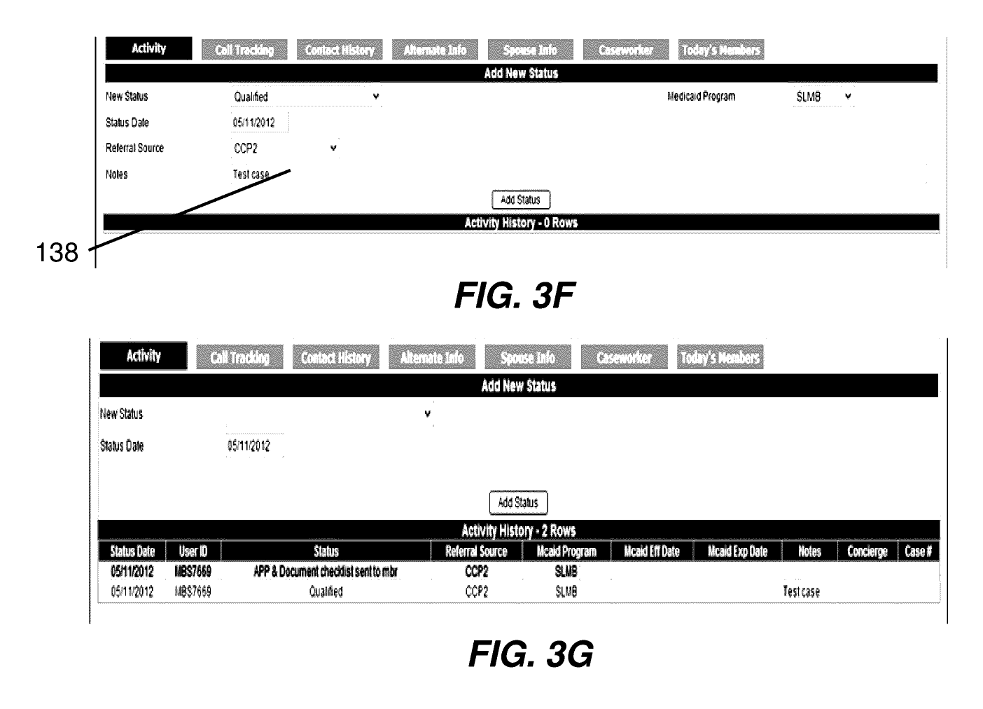

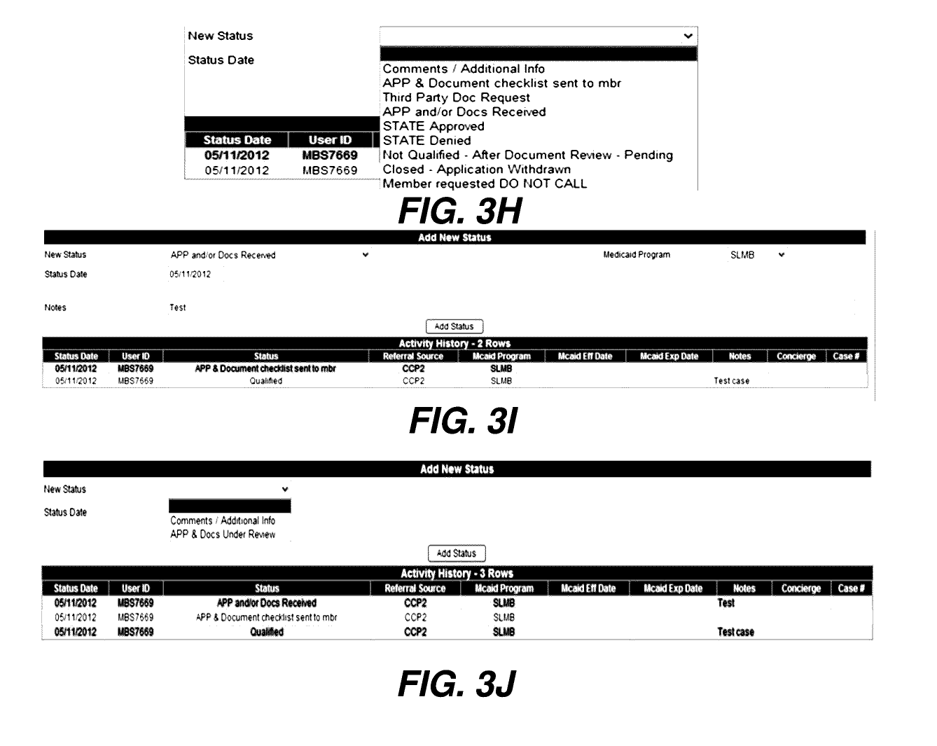

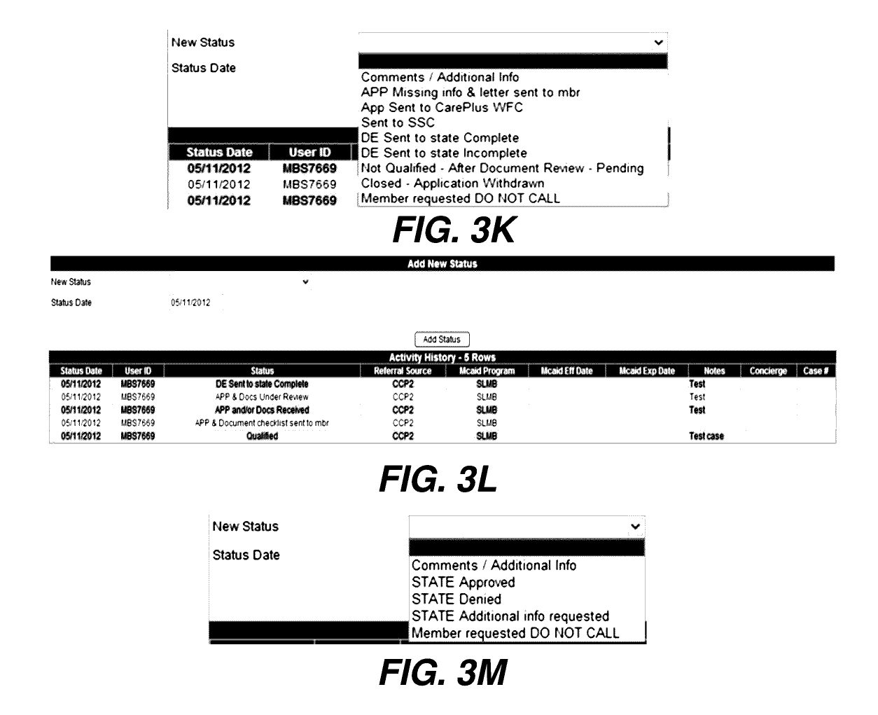

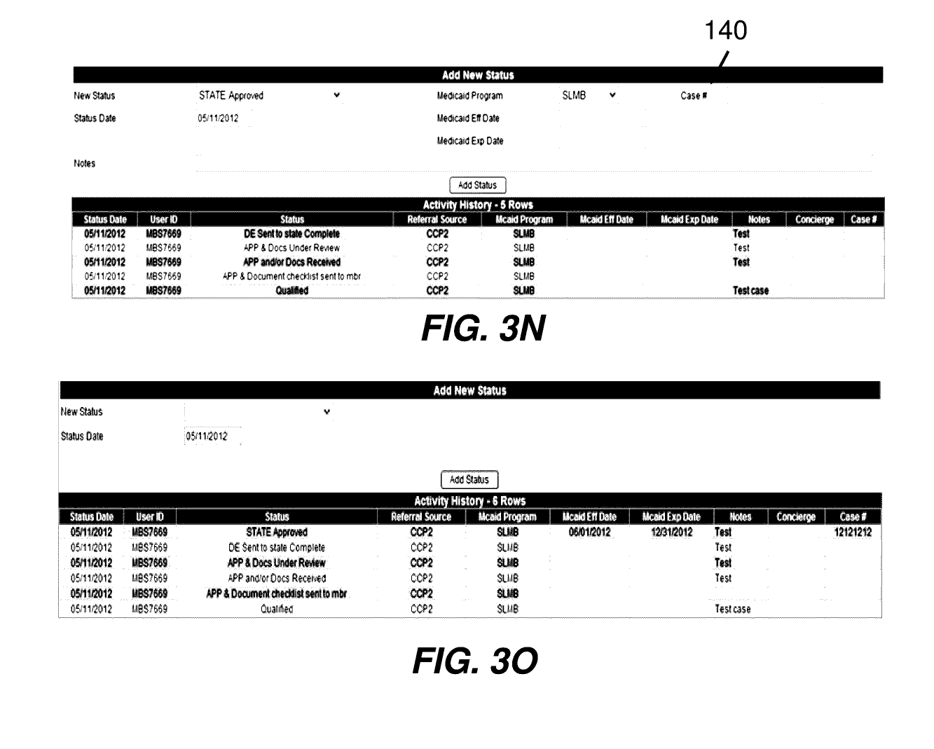

Referring to FIGS. 3A-3O, activity tab functionality for an example embodiment is shown. In an example embodiment, the activity tab is the default tab and is displayed when a user initially selects a member. The activity section is used to enter outreach statuses and note outreach activity steps completed for the member. This section contains an “Add New Status” area 130 and an “Activity History” area 132. The “Add New Status” area 130 is used to log activity related to the MSP application process. The “Activity History” area 132 displays a history of any activity logged in the “Add New Status” section. The activity history displays in descending order.

Referring to FIG. 3B, a sample screen comprising a list of available statuses is shown. The list displays when the user selects an arrow at the right side of the New Status box. The available statuses are determined by the last activity record entered. When no prior activity has occurred for a member, the available statues are:

TABLE 3
Status Codes

| Status | Description |
|---|---|
| Comments/ | Information about a previous note or an entry for a call that |
| Additional | does result in a material change of a member's case status. |
| Info | |
| Qualified | Member's total gross income is below the income and/or asset |
| | limits for their state. |
| Not Qualified | Member's total gross income exceeds the income and/or |
| | asset limits for their state. |
| Closed-Not | Member states he/she does not wish to participate in this |
| Interested | program. |
| Closed-Member | Member states that he/she is already on MSP. (User may then |
| Already on MSP | be instructed to ask the member to mail or fax a copy of the |
| | MSP approval letter. If the member does not have it, the user |
| | may be instructed to order a COLA letter so that the member |
| | can ensure that a part B premium is not currently deducted |
| | from their Social Security check.) |
| Member requested | Member states he/she does not wish to be contacted. |
| DO NOT CALL | |

Referring to FIG. 3C, a sample screen comprising a selected status of “qualified” is shown. Additional entry boxes appear on the screen as a result of the “qualified” status selection. An “add status” option 134 is also visible on the screen. The Status Date defaults to the current date but may be changed. A Medicaid Program box is displayed and has the options as shown in FIG. 3D. The Medicaid Program box 136 identifies the member's dual eligibility category. The categories include:

TABLE 4
Dual Eligibles Categories

| Category | Description |
|---|---|
| Qualified | Individuals entitled to Medicare Part A, have income of |
| Medicare | 100% Federal poverty level (FPL) or less and resources |
| Beneficiaries | that do not exceed twice the limit for SSI eligibility, and |
| without other | are not otherwise eligible for full Medicaid. |
| Medicaid | |
| (QMB) | |
| Specified | Individuals entitled to Medicare Part A, have income of |
| Low-Income | greater than 100% FPL, but less than 120% FPL and |
| Medicare | resources that do not exceed twice the limit for SSI |
| Beneficiaries | eligibility, and are not otherwise eligible for Medicaid. |
| without other | |
| Medicaid | |
| (SLMB) | |
| QMBs with | Individuals entitled to Medicare Part A, have income of |
| full Medicaid | 100% FPL or less and resources that do not exceed |
| (QMB Plus) | twice the limit for SSI eligibility, and are eligible for full |
| | Medicaid benefits. |
| SLMBs with | Individuals entitled to Medicare Part A, have income of |
| full Medicaid | greater than 100% FPL, but less than 120% FPL and |
| (SLMB Plus) | resources that do not in exceed twice the limit for SSI |
| | eligibility, and are eligible for full Medicaid benefits. |
| | Medicaid pays their Medicare Part B premiums and |
| | provides full Medicaid benefits. |
| Qualified | Individuals lost their Medicare Part A benefits due to their |
| Disabled and | return to work. |
| Working | |
| Individuals | |
| (QDWIs) | |
| Qualifying | Annual cap on the amount of money available may limit |
| Individuals (1) | number of individuals in group. Individuals are entitled to |
| (QI-1s) | Medicare Part A, have income of at least 120% FPL, but |
| | less than 135% FPL, resources that do not exceed twice |
| | the limit for SSI eligibility, and are not otherwise eligible |
| | for Medicaid. |
| Qualifying | Annual cap on the amount of money available may limit |
| Individuals (2) | number of individuals in group. Individuals entitled to |
| (QI-2s) | Medicare Part A, have income of at least 135% FPL, but |
| | less than 175% FPL, resources that do not exceed twice |
| | the limit for SSI eligibility, and are not otherwise eligible |
| | for Medicaid. |
| Medicaid Only Dual | Individuals entitled to Medicare Part A and/or Part B and |
| Eligibles (Non QMB, | are eligible for full Medicaid benefits. |
| SLMB, QDWI, QI-1,or QI- | |
| 2) | |

Referring to FIG. 3E, a sample screen with a referral source box is shown. The user identifies the referral source for the Medicaid program for which the member is qualified. Referring to FIG. 3F, a sample screen with an “add notes” option 138 is shown. The user may add notes relevant to status information for the member.

The ability to add notes related to member interactions allows dual eligibility outreach associates to provide important details that may not be discernible from standardized status codes. Examples of notes that may be entered in the notes sections of various screens include the following:

TABLE 5
Example Comments

| Category | Description |
|---|---|
| Members and | If applicable, note spouse's name and UMID. For example, Jane |
| Spouse | Doe (H12345678). If member's spouse is not a member of the |
| | health benefits provider, indicate the spouse's name and non- |
| | member status. For example, Jane Doe (non member). |
| Resend | If member requests another application, note that address was |
| Application | verified. If the address was incorrect, note the correct address in |
| | the comment field and check other databases to confirm it is |
| | incorrect. If it is incorrect, transfer member to customer service so |
| | member can change address. |
| Blank | If member requests a blank application, indicate “Qualified” for the |
| Application | member and spouse. Also indicate “sent blank application to |
| | member” in the comment field. |

The notes sections may be used to record specific details related to user-member interactions. For example, if the member returns a phone call and the user discusses with the member requirements for a specific Medicaid program, the user may record details of the conversation such as which documents the member plans to submit and when as well as the additional documents that the member may need to obtain before completing the program requirements. The ability of the user to record details of every interaction and to determine what has been done as well as what needs to be done for each member allows the user to assist many members in the eligibility and enrollment processes. The detailed information also assists users in assuming responsibility for cases that are in various stages of completion.

After completing each of the data fields and selecting the “add status” option,” a “qualified” status record and an “Application & Document Checklist sent to Member” record are added to the activity History section as shown in FIG. 3G. Based on the updated activity history, the available status codes are shown in FIG. 3H. If the user selects the “APP and/or Docs Received” option as shown in FIG. 3I, the Medicaid Program and Notes boxes display. The Medicaid Program that is displayed is the program selected when the member was qualified but it may be updated if necessary. Following this selection, the available status options are shown in FIG. 3J.

If the user selects the “APP & Docs Under Review” option, the statuses shown in FIG. 3K are available. If the user selects the “DE Sent to state Complete” option, the activity history is updated as shown in FIG. 3L and the available status options are shown in FIG. 3M. Selection of the “STATE Approved” option causes additional entry boxes to display as shown in FIG. 3N. The user is prompted to enter a Medicaid effective date, a Medicaid expiration date, and a case number for an approval record 140. After providing the additional information, the activity history section is updated as shown in FIG. 3O.

As indicated in the examples of FIG. 3A-3O, the available statuses are dynamic and are based on the prior status and the sequencing of the MSP qualification process. A user's options on every screen change in relation to the user's prior selections. A different series of selections results in a series of different screens and options. One of skill in the art would understand that user selections on every screen may be used to determine the content and presentation of subsequent screens.

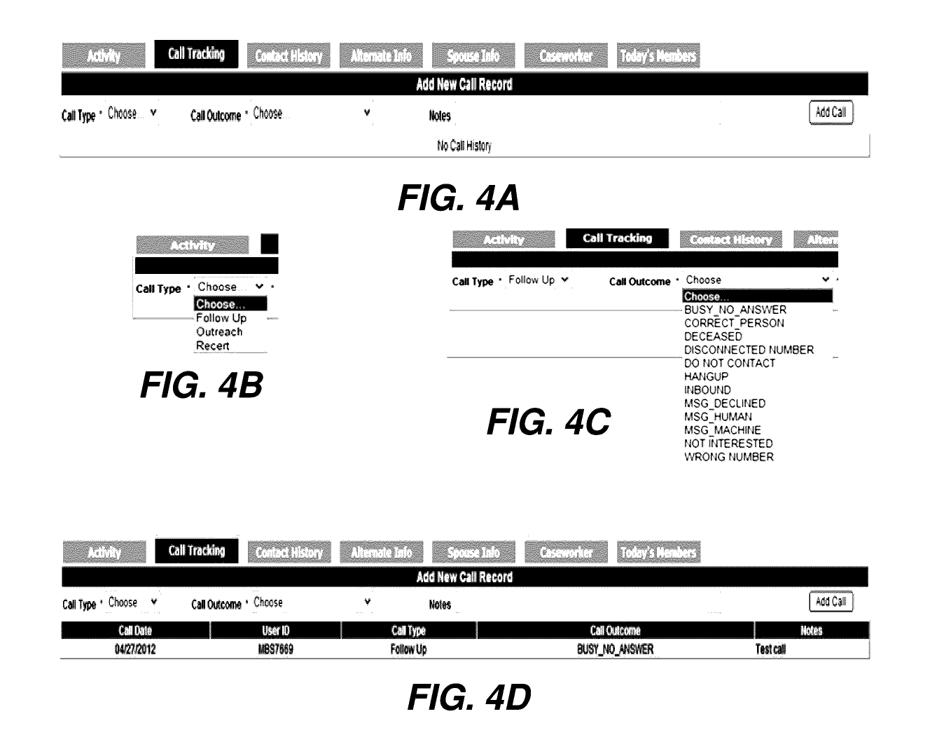

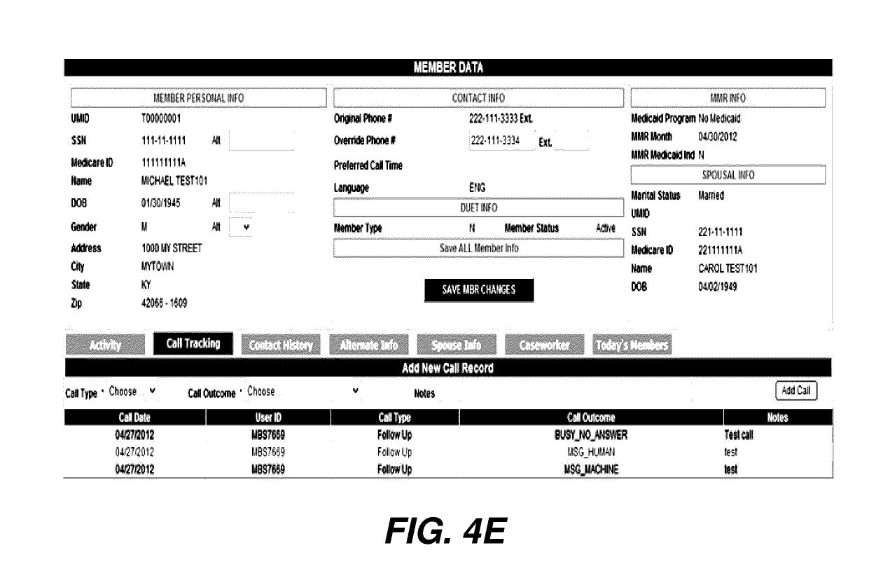

Referring to FIGS. 4A-4E, sample screens for call tracking features according to an example embodiment are shown. Call tracking functionality allows DEO associates to log details of manually dialed outbound phone calls to members. The user accesses the call tracking feature by selecting the call tracking tab as shown in FIG. 4A. Initially, the user selects the appropriate call type from the call type menu as shown in FIG. 4B. Next, the user selects a call outcome as shown in the call outcome menu of FIG. 4C. The user may enter a reason for calling the member and then select the “add call” option as shown in FIG. 4D. The call is then added to the call history as shown in FIG. 4E. If multiple calls have been made to a member, the details are shown in the call history section in descending order.

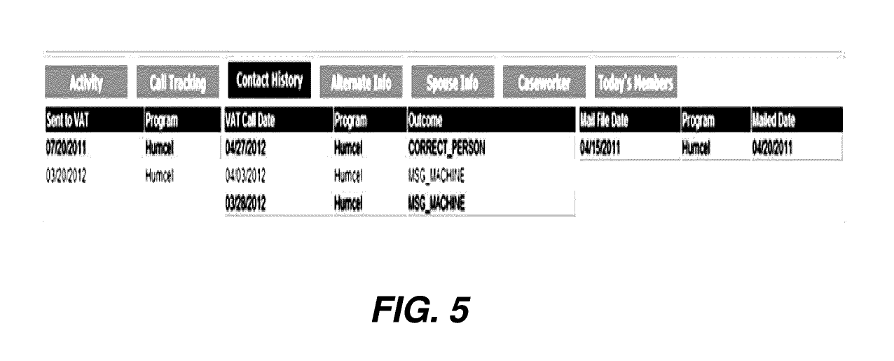

Referring to FIG. 5, a sample contact history screen according to an example embodiment is shown. The contact history screen displays a history of member contact generated through VAT calls, DMS calls, or mailings. The contact history is accessible from the contact history tab and presents details as shown in FIG. 5. Contact history details according to an example embodiment comprise the following:

TABLE 6
Contact History Details

| | |
|---|---|
| Sent to VAT: | Date a member was included in a VAT or DMS |
| | call file |
| Program: | Type of call file |
| VAT Call Date: | Date the member was called |
| Program: | Program type of the call |
| Outcome: | Result of the call to the member |
| Mail File Date: | Date a member was included in a mail file |
| Program: | Program type of the mailing |
| Mailed Date: | Date the letter was mailed to the member |

If the “Sent to VAT” section is blank, the member has not been included in a VAT or DMS file. If the “Sent to VAT” section is not blank but the VAT Call Date section is blank, then either no calls have been made or no results from the VAT or DMS have been received. If the “Mail File Date” section is blank, the member has not been included in a mail file.

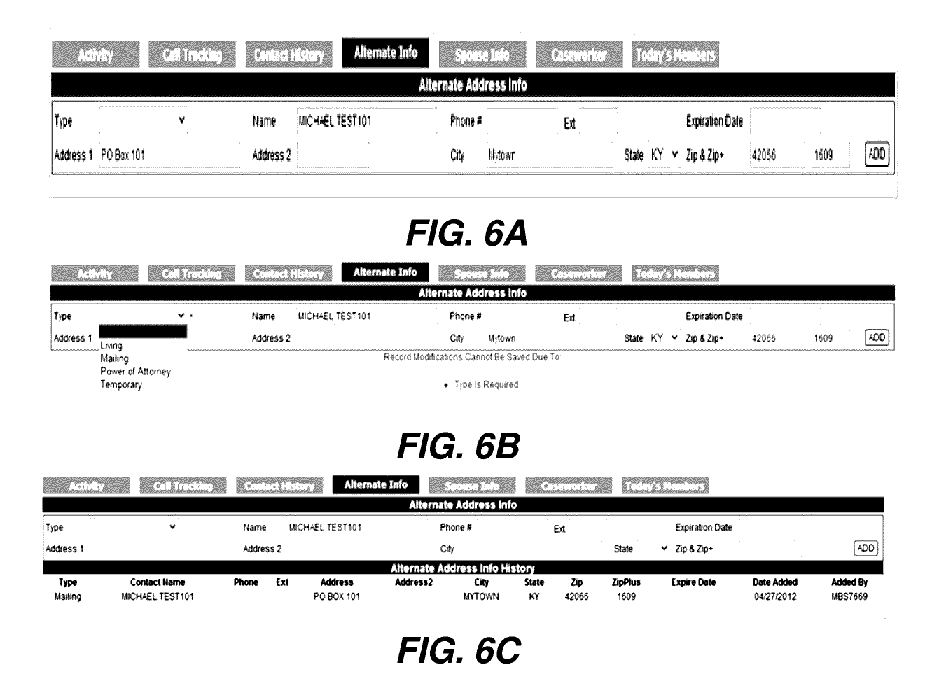

Referring to FIGS. 6A-6C, sample alternate information screens according to an example embodiment are shown. The alternate information section allows entry of alternate or additional addresses and phone numbers. This section also displays a history of any alternate addresses. The user accesses the alternate information section by selecting the “Alternate Info” tab as shown in FIG. 6A. Referring to FIG. 6B, a user completes the following steps to enter a new address:

| | |
|---|---|
| 9) | Select the address type from the dropdown menu. The available types |
| | are: Living; Mailing; Power of Attorney; and Temporary. |
| 10) | Enter the name (the member's name is entered by default). |
| 11) | Enter a phone number and extension if applicable. |
| 12) | Enter an expiration date if applicable. If a temporary is entered, |
| | an expiration date is required. |
| 13) | Enter the address in the Address 1 box. |
| 14) | Enter additional address information in the Address 2 box if needed. |
| 15) | Enter the city, state, and zip code. |
| 16) | Verify the data and select the ADD option. |

The user is alerted if certain information is required before the record can be saved. After adding the record, the alternate information is displayed in the alternate address information history section as shown in FIG. 6C.

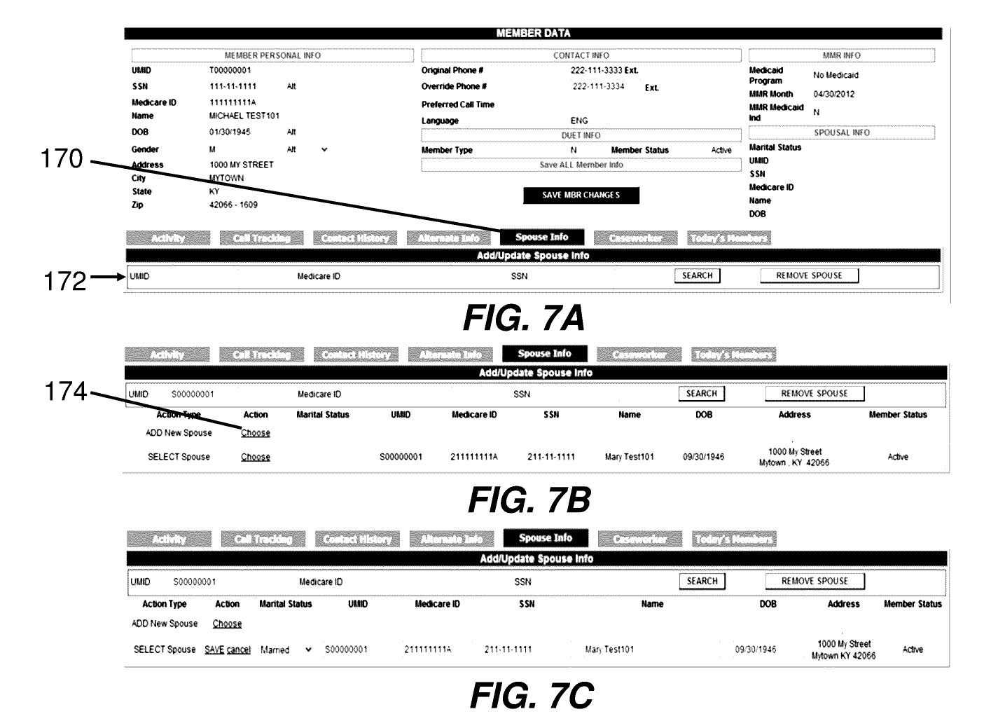

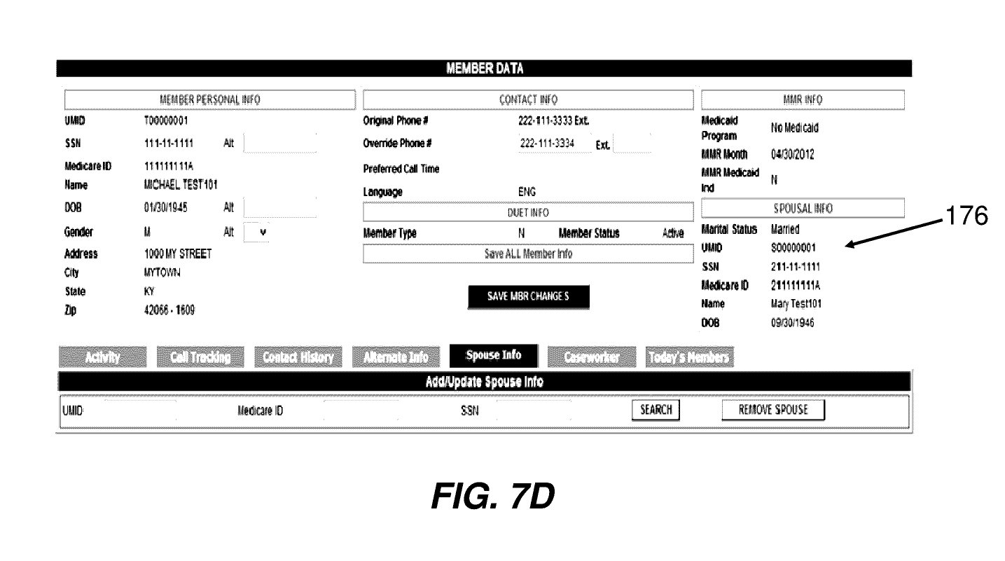

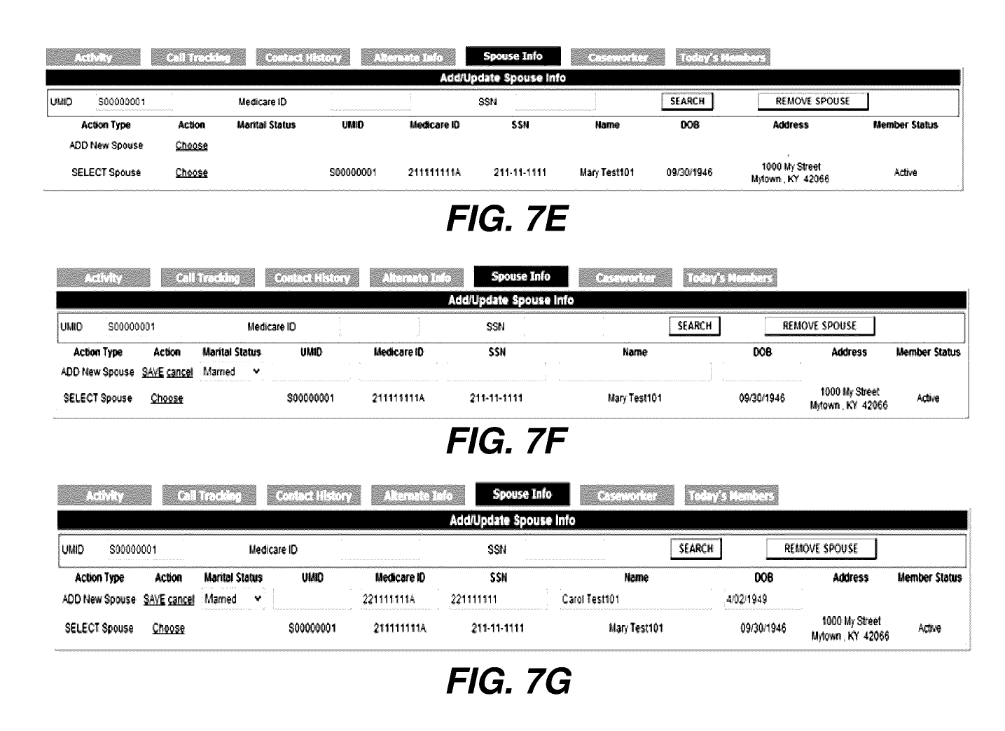

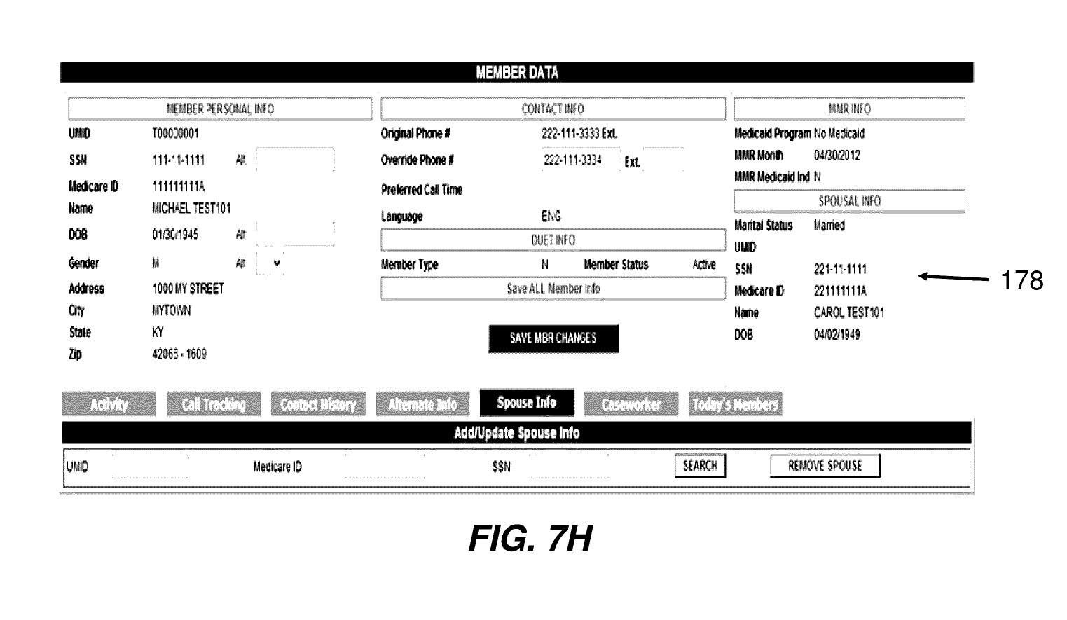

Referring to FIGS. 7A-7H, sample screens for tracking spousal information according to an example embodiment is shown. The spouse information section allows a user to store information about the member's spouse. To access the spouse information section, the user selects the spouse information tab 170 as shown in FIG. 7A. The user has the option of adding or updating information for a spouse or removing spouse data from the member's record.

As shown in FIG. 7B, the user is prompted to enter the spouse's UMID, Medicare ID, or SSN as search criteria 172. The user selects the “SEARCH” option and if a matching record is found, it displays as shown in FIG. 7B.

If the correct spouse information is displayed, the user selects the “Choose” option under the Action column 174. The display change as shown in FIG. 7C and the user may update the spouse's information if corrections are needed. The user selects the SAVE option to save the new information. Referring to FIG. 7D, the spousal information section 176 is populated with the new information.

As indicated in FIGS. 7E-7G, a new spouse may be added by selecting the add spouse option, entering UMID, Medicare ID, SSN, Name, and date of birth information, and selecting the save option. Referring to FIG. 7H, the spousal information section 178 is populated with the new information.

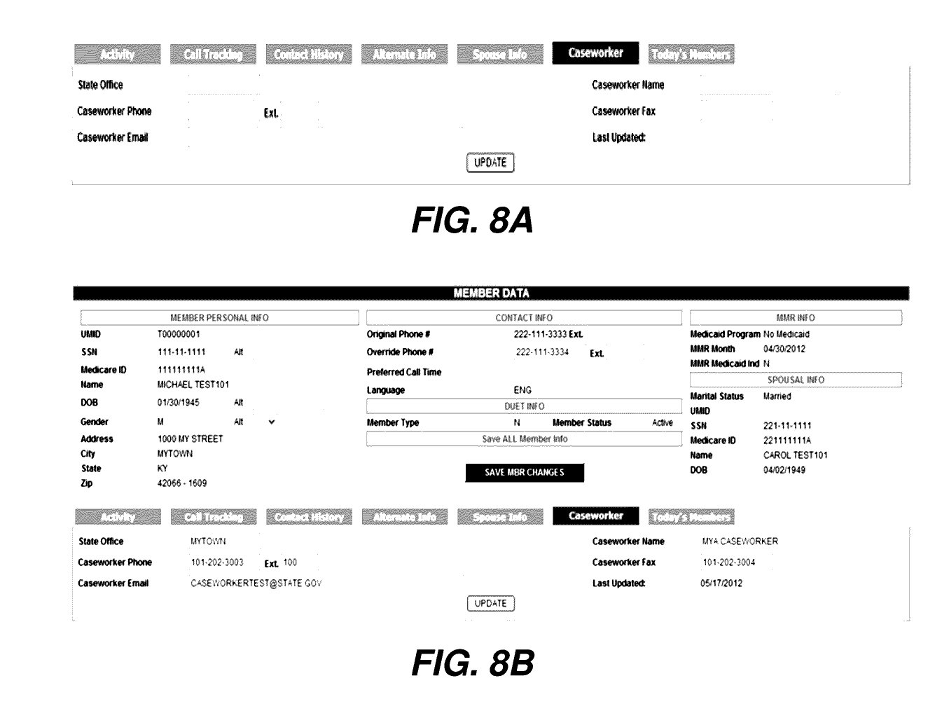

Referring to FIGS. 8A-8B, sample caseworker screens according to an example embodiment are shown. The caseworker section allows the user to store information about the caseworker assigned to the member's MSP application. The user accesses the caseworker section by selecting the caseworker tab as shown in FIG. 8A. The user is prompted for caseworker information and the member record is updated as shown in FIG. 8B.

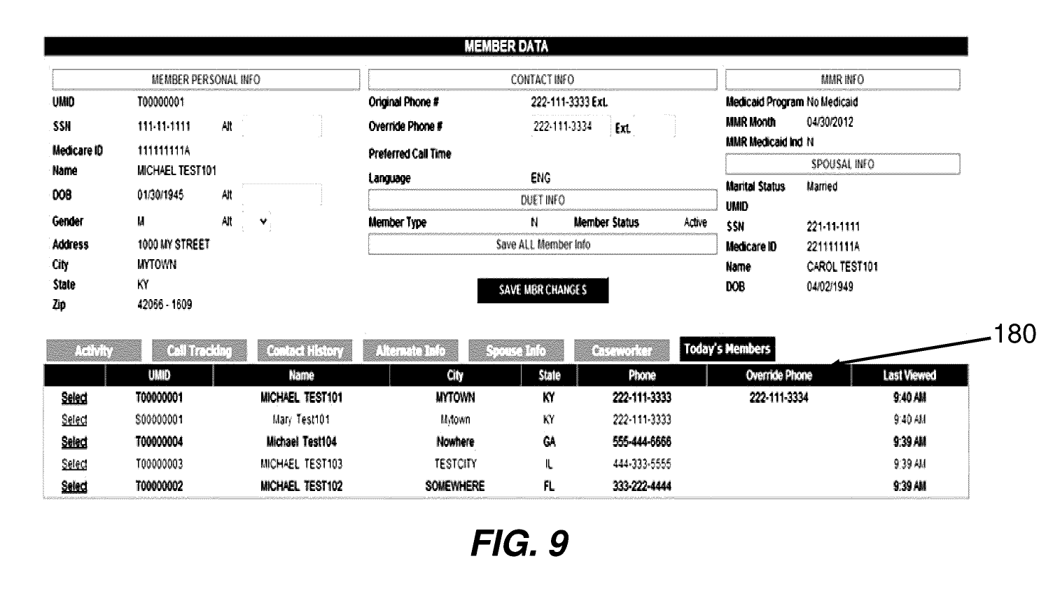

Referring to FIG. 9, a sample “today's members” screen according to an example embodiment is shown. The screen comprises a “today's members” section 180 identifying the members with which the user worked throughout the day.

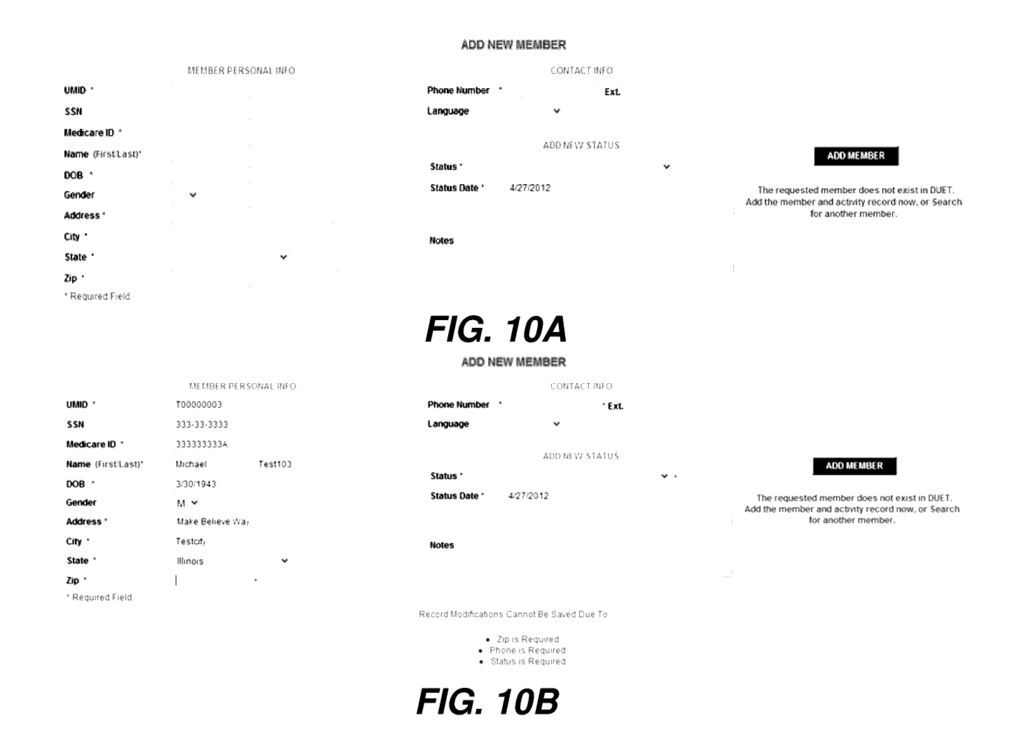

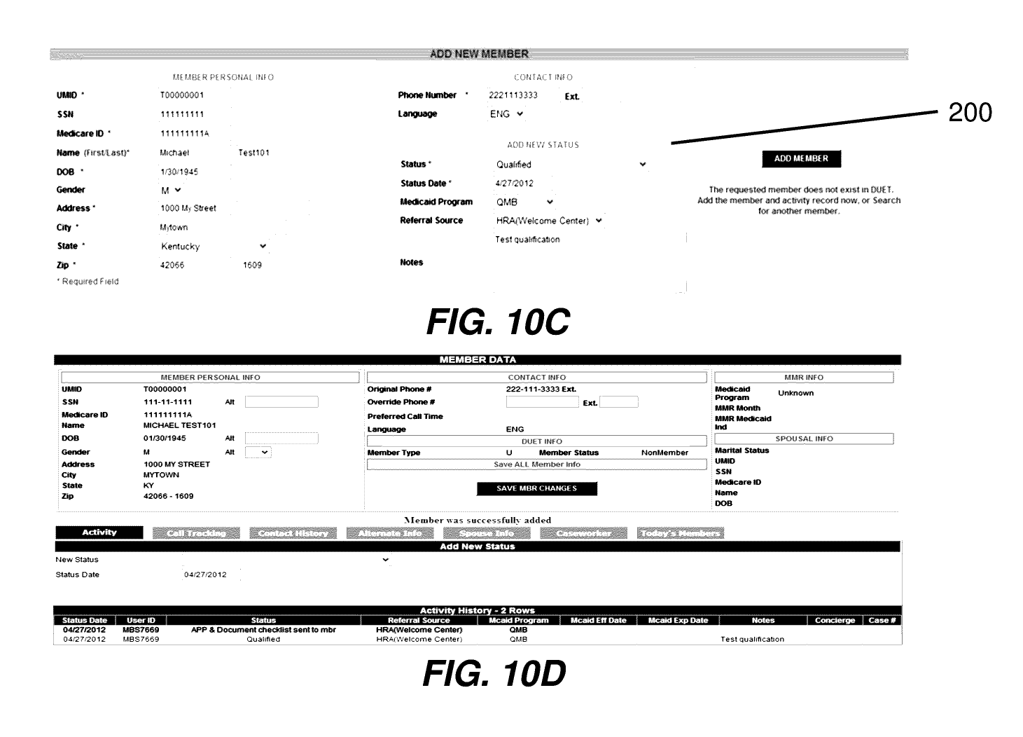

Referring to FIGS. 10A-10D, sample “add new member” screens according to an example embodiment are shown. The user is prompted for member information as shown in FIG. 10A and may be alerted if required information is not provided as shown in FIG. 10B. The user may further provide new status information by responding to prompts in the “add new status” section 200 as shown in FIG. 10C. Referring to FIG. 10D, after the user has provided the new member information, the user may receive a message indicating the new member was successfully added.

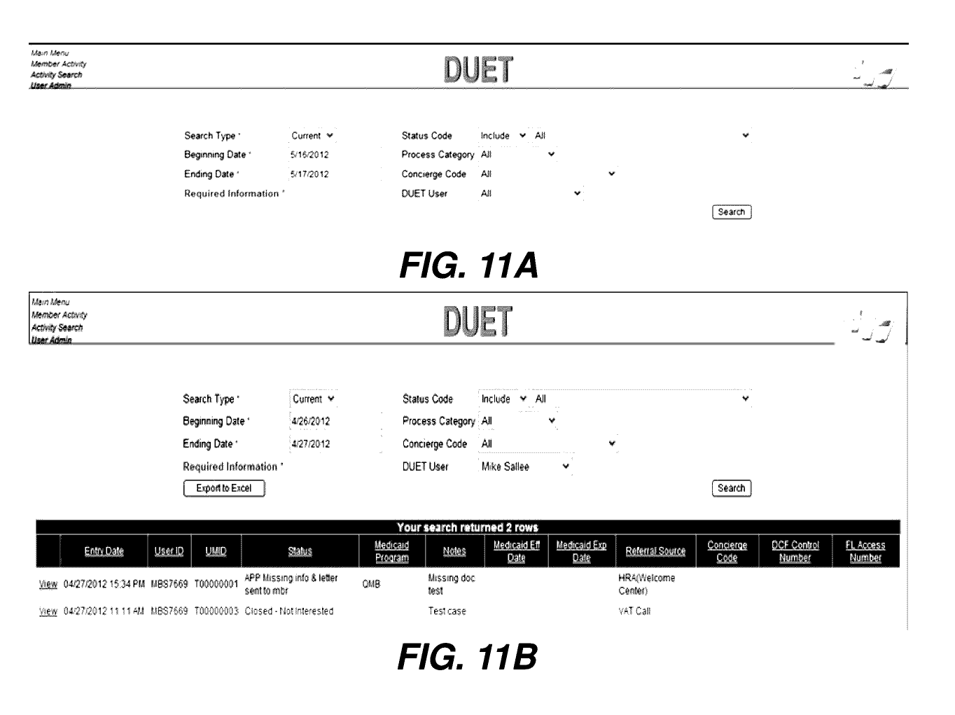

Referring to FIGS. 11A and 11B, sample “activity search” screens according to an example embodiment are shown. As shown in FIG. 11A, the user may enter various search criteria. Referring to FIG. 11B, a sample search results screen is shown.

The computerized system and method allows associates of a health benefits provider to assist its “dual eligible” members with eligibility and enrollment procedures for other health benefit programs. The associates may access the information they need to identify members that are eligible for other health benefits programs and for eligible members, enroll them in the programs. The computerized system and method support numerous events from an initial contact with the member through conclusion of an eligibility determination, and if applicable, enrollment. The computerized system and method further support suspension of an eligibility evaluation or enrollment procedure for various reasons that may be recorded in the member's contact history.

While certain embodiments of the present invention are described in detail above, the scope of the invention is not to be considered limited by such disclosure, and modifications are possible without departing from the spirit of the invention as evidenced by the claims. For example, elements of the user interface may be varied and fall within the scope of the claimed invention. Various aspects of data recording and presentation may be varied and fall within the scope of the claimed invention. One skilled in the art would recognize that such modifications are possible without departing from the scope of the claimed invention.

1. A computerized method for tracking dual eligibility of members of a health insurance plan comprising:
(a) storing in at least one database:
(i) member records limited to a plurality of members confirmed to be eligible for a first health insurance plan, each said member record comprising:
(1) member identifying data;
(2) member status data comprising an indication of whether the member is interested in information pertaining to a second health insurance plan, and an indication regarding the member's willingness to be contacted about said second health insurance plan; and
(3) at least one eligibility confirming activity record comprising:
(A) a status date; and
(B) eligibility status data for an eligibility category of a second health insurance plan providing health benefits supplemental to said first health insurance plan where said second health insurance plan is a Medicaid savings program; and
(ii) eligibility requirements for said second health insurance plan providing health benefits supplemental to said first health insurance plan where such requirements specifically require that the member be enrolled in the first health insurance plan;
(b) receiving at a computer processor member identifying data for one of said plurality of members;
(c) retrieving by said computer processor from said database a member record with said received member identifying data;
(d) generating by said computer processor and transmitting for display at a user computer a screen display comprising:
(1) said received member identifying data; and
(2) at least one eligibility confirming activity record with:
(i) said status date;
(ii) said eligibility category for said second health insurance plan; and
(iii) said eligibility status data for said eligibility category of said second health insurance plan indicating said member is currently not eligible for said second health insurance plan;
(e) receiving at said computer processor from said user computer a request to add a new eligibility confirming activity record to said member record;
(f) receiving at said computer processor from said user computer, data for said new eligibility confirming record comprising:
(i) a new status date;
(ii) a selected eligibility category;
(g) determining by said computer processor a plurality of eligibility status codes applicable to:
(i) said member's eligibility status according to said new eligibility confirming activity record; and
(ii) said member's eligibility status according to eligibility requirements for said second health insurance plan;
(h) receiving at said computer processor from said user computer a selection of a new eligibility status code from said plurality of eligibility status codes, said new eligibility status code is selected from the group consisting of: qualified, not qualified, not interested, previously qualified, and do not call; and
(i) updating by said computer processor said database with said new eligibility confirming activity record comprising:
(i) said new eligibility status code for said second health insurance plan;
(ii) said new status date; and
(iii) said selected eligibility category.

2. (canceled)

3. The computerized method of claim 1 wherein said new eligibility status code comprises status data for an application for said second health insurance plan.

4. The computerized method of claim 1 wherein said eligibility confirming activity record further comprises a referral source.

5. (canceled)

6. The computerized method of claim 1 wherein said member record further comprises at least one contact history record comprising an outcome of a contact with said member.

7. The computerized method of claim 1 wherein said member record further comprises at least one call tracking record comprising a call type and a call outcome.

8. A computerized system for tracking dual eligibility of members of a health insurance plan comprising:
(a) at least one database storing:
(i) for each of a plurality of members confirmed to be eligible for a first health insurance plan a member record comprising:
(1) member identifying data; and
(2) at least one contact history record comprising a contact date and a contact outcome where said contact outcome is selected from the group consisting of: qualified, not qualified, not interested, previously qualified, and do not call;
(3) at least one eligibility confirming activity record comprising:
(A) a status date; and
(B) eligibility status data for an eligibility category of a second health insurance plan providing health benefits supplemental to said first health insurance plan where said second health insurance plan is a Medicaid savings program and said eligibility status data comprises a code selected from the group consisting of: qualified, not qualified and previously qualified; and
(ii) eligibility requirements for said second health insurance plan providing health benefits supplemental to said first health insurance plan where said second health insurance plan is a Medicaid savings program;
(b) a computer processor executing programming instructions to:
(1) receive an additional contact date and an additional contact outcome for at least one additional contact with each of said plurality of members where said contact outcome is selected from the group consisting of: qualified, not qualified, not interested, previously qualified, and do not call;
(2) update said contact history in said at least one database for each of said plurality of members with said additional contact date and said additional contact outcome for said at least one additional contact;
(3) receive member identifying data for one of said plurality of members;
(4) retrieve from said database a member record with said member identifying data;
(5) generate and transmit a screen display comprising:
(i) said member identifying data; and
(ii) at least one eligibility confirming activity record with:
(A) said status date;
(B) said eligibility category for said second health insurance plan; and
(C) said eligibility status data for said eligibility category of said second health insurance plan indicating said member is currently not eligible for said second health insurance plan;
(6) determine by said computer processor a plurality of status codes applicable to:
(i) said member's eligibility status according to a new eligibility confirming activity record comprising:
(A) a new status date;
(B) a selected eligibility category; and
(ii) said member's eligibility status according to eligibility requirements for said second health insurance plan;
(7) receive a selection of a new eligibility status code from said plurality of eligibility status codes, said codes selected from the group consisting of: qualified, not qualified, not interested, previously qualified, and do not call;
(8) receive a request to add said new eligibility confirming activity record to said member record, said new eligibility confirming activity record comprising said new status date, said selected eligibility category, and said new eligibility status code for said second health insurance plan; and
(c) a user computer in communication with said computer processor executing programming instructions to:
(1) receive from said computer processor said screen display;
(2) display said screen display comprising:
(i) said member identifying data; and
(ii) at least one eligibility confirming activity record with:
(A) said status date;
(B) said eligibility category for said second health insurance plan; and
(C) said eligibility status data for said second health insurance plan;
(3) receive and transmit to said computer processor said new status date, said selected eligibility category, and said selection of said new eligibility status code from said plurality of eligibility status codes; and
(4) receive and transmit to said computer processor said request to add to said member record said new eligibility confirming activity record with said new status date, said selected eligibility category, and said new eligibility status code for said selected eligibility category of said second health insurance plan.

9. The computerized system of claim 8 wherein said additional contact outcome is selected from the group consisting of a response to a voice activated technology call and a response to a direct mail inquiry.

10. (canceled)

11. The computerized system of claim 8 wherein said computer processor further executes programming instructions to:
(d) add to said member record a new call tracking record, said call tracking record comprising:
(1) a call type; and
(2) a call outcome.

12. The computerized system of claim 11 wherein said call type is selected from the group consisting of:
follow up, outreach, and recertification.

13. The computerized system of claim 8 wherein said call outcome is selected from the group consisting of:
busy, correct person, deceased, busy number, do not contact, hangup, inbound, message declined, message human, message machine, not interested, and wrong number.

14. The computerized system of claim 8 wherein said computer processor further executes programming instructions to:
(d) add to said member record spousal tracking information.

15. A computerized method for tracking dual eligibility of members of a health insurance plan comprising:
(a) storing in at least one database:
(i) for each of a plurality of members confirmed to be eligible for a first health insurance plan a member record comprising:
(1) member identifying data;
(2) member status data comprising an indication of whether the member is interested in information pertaining to a second health insurance plan, and an indication regarding the member's willingness to be contacted about said second health insurance plan;
(3) at least one contact history record comprising a contact date and a contact outcome; and
(4) at least one eligibility confirming activity record comprising:
(A) a status date; and
(B) eligibility status data for an eligibility category of a second health insurance plan providing health benefits supplemental to said first health insurance plan where said second health insurance plan is a Medicaid savings program; and
(ii) eligibility requirements for said second health insurance plan providing health benefits supplemental to said first health insurance plan where such requirements include the consideration of member income;
(b) receiving at a computer processor an additional contact date and an additional contact outcome for at least one additional contact with each of said plurality of members;
(c) updating said contact history in said at least one database for each of said plurality of members with said additional contact date and said additional contact outcome for said at least one additional contact;
(d) receiving at said computer processor member identifying data for one of said plurality of members;
(e) retrieving by said computer processor from said database a member record with said received member identifying data;
(f) generating by said computer processor and transmitting for display at a user computer a screen display comprising:
(1) said member identifying data; and
(2) at least one eligibility confirming activity record with:
(i) said status date;
(ii) said eligibility category for said second health insurance plan; and
(iii) said eligibility status data for said eligibility category of said second health insurance plan indicating said member is currently not eligible for said second health insurance plan;
(g) determining by said computer processor a plurality of eligibility status codes, said status codes selected from the group consisting of: qualified, not qualified, and previously qualified applicable to:
(i) said member's eligibility status according to a new eligibility confirming activity record comprising:
(A) a new status date;
(B) a selected eligibility category; and
(ii) said member's eligibility status according to eligibility requirements for said second health insurance plan;
(h) receiving at said computer processor from said user computer a selection of a new eligibility status code from said plurality of eligibility status codes wherein said new eligibility status code is selected from the group consisting of: qualified, not qualified, not interested, previously qualified, and do not call; and
(i) receiving at said computer processor a request to add said new eligibility confirming activity record to said member record, said new eligibility confirming activity record comprising said new status date, said selected eligibility category, and said new eligibility status code for said selected eligibility category of said second health insurance plan.

16. The computerized method of claim 15 wherein said additional contact outcome is selected from the group consisting of a response to a voice activated technology call and a response a direct mail inquiry.

17. (canceled)

18. The computerized method of claim 15 further comprising:
(j) receiving at said computer processor a request to add a new call tracking record to said member record, said call tracking record comprising:
(1) a call type; and
(2) a call outcome.

19. The computerized method of claim 18 wherein said call type is selected from the group consisting of:
follow up, outreach, and recertification.

20. The computerized method of claim 18 wherein said call outcome is selected from the group consisting of:
busy, correct person, deceased, busy number, do not contact, hangup, inbound, message declined, message human, message machine, not interested, and wrong number.
